(19) United States
(12) Patent Application Publication
(10) Pub. No.: US 2007/0284913 A1
(43) Pub. Date: Dec. 13, 2007

(54) Wall Construction For A Trailer

(76) Inventor: Rodney P. Ehrlich, Monticello, IN (US)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 11/759,341

(22) Filed: Jun. 7, 2007

Related U.S. Application Data
(60) Provisional application No. 60/812,546, filed on Jun. 9, 2006.

(51) Int. Cl. B62D 25/02

(52) U.S. Cl. 296/186.1

(57) ABSTRACT

A sidewall of a trailer is provided. The sidewall includes at least one inner skin and at least one outer skin which are spaced apart by posts. A bottom rail has a portion which extends between the inner and outer skins. A top rail has a portion which extends between the inner and outer skins. The skins and the bottom rail are secured together by an adhesive, by fasteners, or by a combination of adhesive and fasteners. The skins and the top rail are secured together by an adhesive, by fasteners, or by a combination of adhesive and fasteners. The inner and outer skins and the posts are attached together by an adhesive, by fasteners, or by a combination of adhesive and fasteners.

### CROSS-REFERENCE AND INCORPORATION BY REFERENCE

This patent application claims the benefit of domestic priority of United States Provisional Application Ser. No. 60/812,546, filed Jun. 9, 2006, and entitled “Wall Construction For A Trailer”. United States Provisional Application Ser. No. 60/812,546 is hereby incorporated by reference.

### FIELD OF THE INVENTION

This invention is generally directed to a sidewall for a trailer. More particularly, the present invention provides a sidewall for a trailer which incorporates the bottom rail of the trailer and the top rail of the trailer into the structure of the sidewall.

### BACKGROUND OF THE INVENTION

Prior art trailers have a base rail which is stacked on the inside or outside of the side wall components. As a result, this construction adds to the overall width of the side wall and reduces the available interior dimension of the trailer.

The present invention provides a sidewall which overcomes the problems presented in the prior art and which provides additional advantages over the prior art, such advantages will become clear upon a reading of the attached specification in combination with a study of the drawings.

### SUMMARY OF THE INVENTION

A sidewall of a trailer is provided. The sidewall includes at least one inner skin and at least one outer skin which are spaced apart by posts. A bottom rail has a portion which extends between the inner and outer skins. A top rail has a portion which extends between the inner and outer skins. The skins and the bottom rail are secured together by an adhesive, by fasteners, or by a combination of adhesive and fasteners. The skins and the top rail are secured together by an adhesive, by fasteners, or by a combination of adhesive and fasteners. The inner and outer skins and the posts are attached together by an adhesive, by fasteners, or by a combination of adhesive and fasteners.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a perspective view of a first embodiment of a trailer which incorporates sidewalls which are formed in accordance with features of the present invention;

FIG. 2 is a partial perspective of the sidewall of FIG. 1 with a portion cut away;

FIG. 3 is a cross-sectional view of the sidewall along line 3-3 of FIG. 2;

FIG. 4 is an enlarged partial cross-sectional view of the sidewall of FIG. 1;

FIG. 4A is an enlarged partial cross-sectional view of an alternative sidewall;

FIG. 4B is an enlarged partial cross-sectional view of an alternative sidewall;

FIG. 4C is an enlarged partial cross-sectional view of an alternative sidewall;

FIG. 5 is a cross-sectional view of a lap joint which can be used in the first embodiment;

FIG. 6 is a cross-sectional view of an abutting joint which can be used in the first embodiment;

FIG. 7 is a perspective view of a second embodiment of a trailer which incorporates sidewalls which are formed in accordance with features of the present invention;

FIG. 8 is a partial perspective of the sidewall of FIG. 7 with a portion cut away;

FIG. 9 is a cross-sectional view of the sidewall along line 9-9 of FIG. 8;

FIG. 10 is a enlarged partial cross-sectional view of the sidewall of FIG. 7;

FIG. 11 is a cross-sectional view of a lap joint which can be used in the second and third embodiments;

FIG. 12 is a cross-sectional view of an abutting joint which can be used in the second and third embodiments;

FIG. 13 is a perspective view of the third embodiment of a trailer which incorporates sidewalls which are formed in accordance with features of the present invention;

FIG. 14 is a partial perspective of the sidewall of FIG. 13 with a portion cut away;

FIG. 15 is a cross-sectional view of the sidewall along line 15-15 of FIG. 14;

FIG. 16 is a enlarged partial cross-sectional view of the sidewall of FIG. 13;

FIGS. 17-20 show cross-section views of alternate joints for joining panels which form the sidewall; and

FIGS. 21-24 show different cross-sectional view of the posts that may be used in the joints.

### DETAILED DESCRIPTION OF THE ILLUSTRATED EMBODIMENTS

While the invention may be susceptible to embodiment in different forms, there is shown in the drawings, and herein will be described in detail, specific embodiments with the understanding that the present disclosure is to be considered an exemplification of the principles of the invention, and is not intended to limit the invention to that as illustrated and described herein.

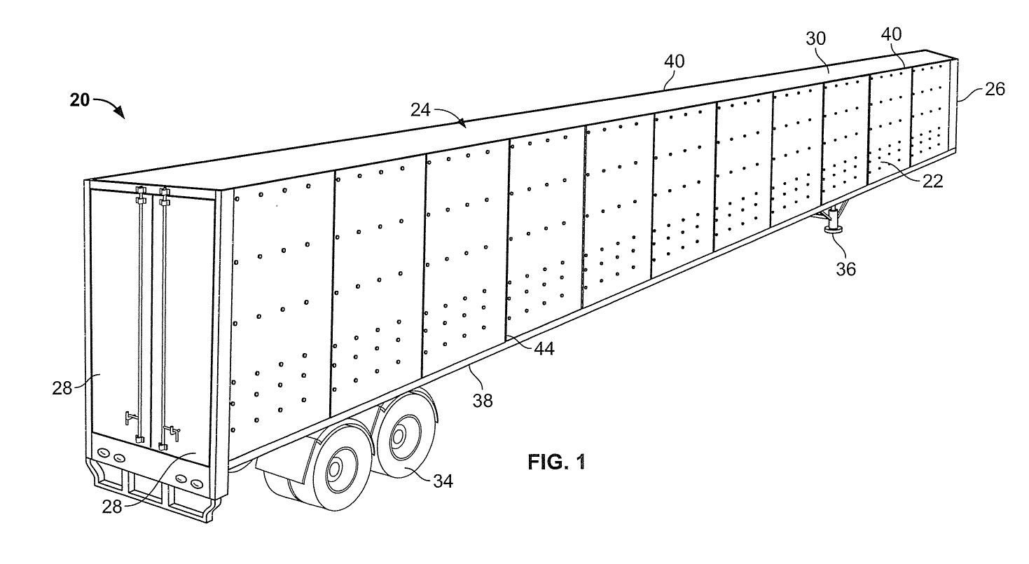

Attention is invited to the first embodiment of the trailer 20 shown in FIGS. 1-5. The trailer 20 includes a body 24 formed from a pair of rectangular sidewalls 22, a front wall 26, rear frame and doors 28, a roof structure 30, and a floor structure 32. The rear of the floor structure 32 is supported by a conventional rear undercarriage assembly 34 and the front of the floor structure 32 has a landing gear 36 secured thereunder. The floor structure 32 and a lower portion of each sidewall 22 are secured to a respective bottom rail 38 which extends the length of the trailer 20. The bottom rails 38 are preferably formed of aluminum, which may be extruded. The roof structure 30 and an upper portion of each sidewall 22 are secured to a respective top rail 40 which extends the length of the trailer 20. The top rails 40 are preferably formed of aluminum, which may be extruded. The trailer 20 can be connected to a tractor (not shown) by conventional means, such as a fifth wheel assembly.

The sidewalls 22 are formed of a plurality of panels 23 which are identical to one another in configuration and, as such, only one of the panels 23 is described. Each panel 23 has an outer skin 42 and an inner skin 46. Adjacent panels 23 of the sidewall 22 are joined together at a joint 44. Each skin 42 and 46 may be forty-nine (49) inches in length or may have other lengths. Each outer skin 42 and each inner skin 46 can be formed of a thin metal skin, preferably formed of aluminum or steel, and can range in thickness (such as 0.013 to 0.026 for steel skins and 0.050 inches for aluminum skins) or may be a thin composite material and can range in thickness (such as 0.026); other suitable or like materials may also be used. It is to be understood that other lengths or thicknesses may be used as required by the application.

Each panel 23 further includes a plurality of posts 48 mounted between the outer and inner skins 42 and 46. Each post 48 extends along the height of the respective sidewall 22 between the bottom and top rails 38, 40 and spans the width between the outer and inner skins 42, 46. Adjacent posts 48 are preferably spaced-apart from one another such that voids are provided between adjacent posts 48 and the outer and inner skins 42, 46. The posts 48 are preferably formed of a metal material, such as aluminum or steel. As illustrated in FIG. 4, the inner skins 46 are preferably attached to the posts 48 by a structural adhesive 50. As an alternative, as illustrated in FIG. 4A, the outer skins 42a may be attached to the posts 48a (and no adhesive is provided between the inner skins 46a and the posts 48a) by adhesive 50a. As another alternative, as illustrated in FIG. 4B, both the outer and inner skins 42b, 46b may be attached to the posts 48b by adhesive 50b. As yet another alternative, as illustrated in FIG. 4C, the adhesive can be eliminated from between the outer skins 42c and the posts 48c, and from between the inner skins 46c and the posts 48c.

As shown, each outer and inner skin 42 and 46 overlaps three (3) posts 48, but it is to be understood that outer and inner skins 42 and 46 can overlap more or fewer posts 48. The posts 48 provide all of the structural integrity for the panels 23 such that it is unnecessary, and even undesirable, to include any type of core material within the voids formed between adjacent posts 48 as it will add weight to the panels 23 and the sidewalls 22. First end portions 59a, 61a of the outer and inner skins 42, 46 extend beyond one of the posts 48 most proximate to a first end 63 of the panel 23; second end portions 59b, 61b of the outer and inner skins 42, 46 extend beyond another one of the posts 48 most proximate to a second end 65 of the panel 23.

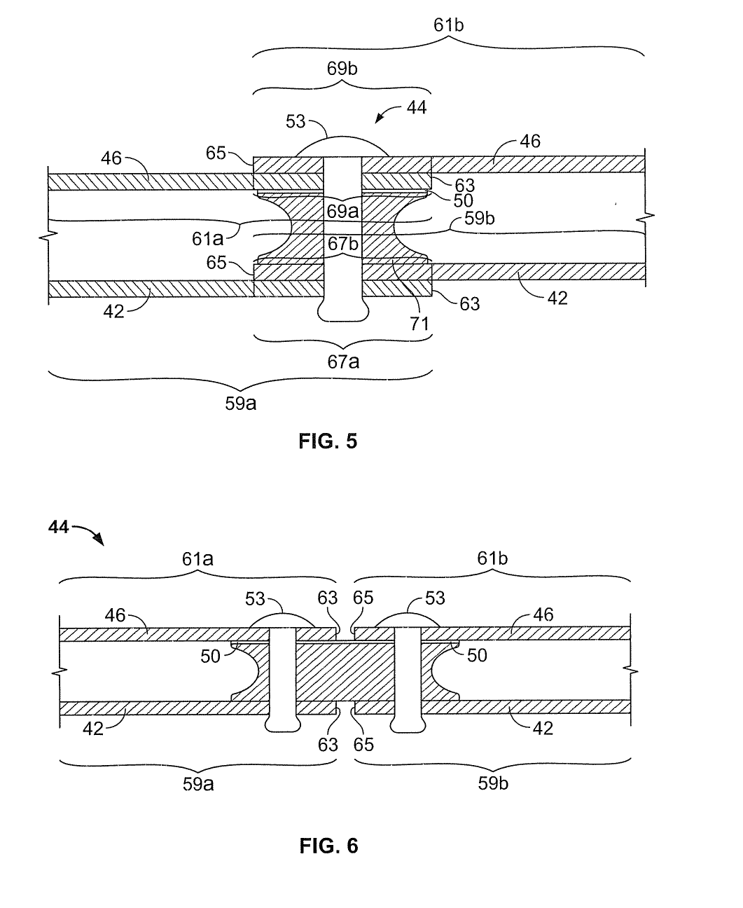

As shown in the first embodiment, and specifically in FIG. 5, the adjacent panels 23 are joined together at joints 44, which are lap joints. At the joints 44, portions 67a of the first end portions 59a of the outer skins 42 of one panel 23 overlap portions 67b of the second end portions 59b of the outer skins 42 of an adjacent panel 23, and portions 69a of the first end portions 61a of the inner skins 46 of the one panel 23 overlap portions 69b of the second end portions 61b of the inner skins 46 of the adjacent panel 23. A post 71, which is preferably identical to the posts 48, is positioned between the overlapping portions 67a, 67b of the outer skins 42 and the overlapping portions 69a, 69b of the inner skins 46. Preferably, the post 71 is attached to one of the overlapping portions 69a, 69b of the inner skins 46 by a structural adhesive 50. While not illustrated, it is to be understood that adhesives could also or alternatively be used to attach the post 71 to one of the overlapping portions 67a, 67b of the outer skins 42, to attach the overlapping portions 67a, 67b of the outer skins 42 together, and to attach the overlapping portions 69a, 69b of the inner skins 46 together.

Alternatively, as shown in FIG. 6, the posts 71 can be made wider and the end 63 of the first end portion 59a of one of the outer skins 42 can face the end 65 of the second end portion 59b of the adjacent outer skin 42, whether separated from (as illustrated), or abutting against, one another, with each outer skin 42 being attached to the post 71 at the joint 44; and the end 63 of the first end portion 61a of one of the inner skins 46 can face the end 65 of the second end portion 61b of the adjacent inner skin 46, whether separated from (as illustrated), or abutting against, one another, with each inner skin 46 being attached to the post 71 at the joint 44. Preferably, the post 71 is attached to each of the end portions 61a, 61b of the inner skins 46 by a structural adhesive 50. While not illustrated, it is to be understood that adhesives could also or alternatively be used to attach the post 71 to the end portions 59a, 59b of the outer skins 42.

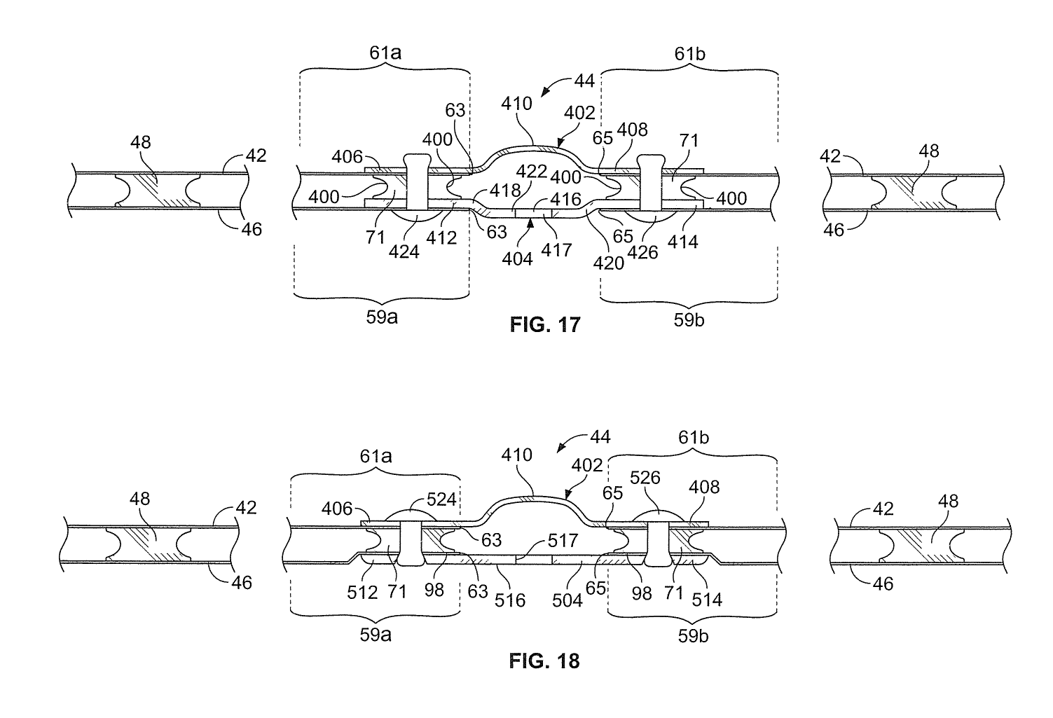

Another alternative for forming the joints 44 between adjacent inner and outer skins 42, 46 is shown and herein discussed in further detail with regard to FIGS. 17-20. If desired, some or all of the end portions 59a, 59b; 61a, 61b of the outer skins 42 and/or the inner skins 46 may be stepped by suitable means.

A conventional scuff plate 52 is proximate to and may abut against the inner surface of the inner skins 46. The scuff plate 52 may be formed of metal, wood, a composite material, or any other suitable material.

At the locations where the joints 44 are provided, a plurality of spaced apart fasteners 53, preferably rivets, are provided along the height of the posts 71. As illustrated in FIG. 5, the fasteners 53 extend through both of the overlapping portions 67a, 67b of the outer skins 42, the post 71, and both of the overlapping portions 69a, 69b of the inner skins 46, thus securing them all together. It should be noted that, while not a preferred embodiment, the fasteners 53 would allow for the structural adhesive 50 securing the inner skins 46 to the post 71, as illustrated, to not be utilized.

Alternatively, as illustrated in FIG. 6, the fasteners 53 extend through the first end portion 59a of the outer skin 42 of one of the panels 23, the post 71, and the first end portion 61a of the inner skin 46 of the one panel 23, thus securing them all together, and further extend through the second end portion 59b of the outer skin 42 of the other one of the panels 23, the post 71, and the second end portion 61b of the inner skin 46 of the other one of the panels 23, thus securing them all together. It should be noted that, while not a preferred embodiment, the fasteners 53 would allow for the structural adhesive 50 securing the inner skins 46 to the post 71, as illustrated, to not be utilized.

The lower fasteners 53 may also extend through the scuff plate 52. The fasteners 53 are provided at spaced apart locations, such as one and half inches on centers or two inches on centers (it is to be understood that other spacings may be used), along the height of the post 71. The fasteners 53 may be provided closer together if desired. One of the fasteners denoted as 53a is provided proximate the top of the post 71 and one the fasteners denoted as fastener 53b is proximate the top of the scuff plate 52. The lowermost fasteners 53 also extend through the scuff plate 52. Of these lowermost fasteners, a fastener denoted as 53c is provided proximate the bottom of the post 71 and a fastener denoted as 53d is proximate the top of the scuff plate 52.

At non-joint locations where posts 48 are provided, a plurality of spaced apart fasteners 54, 56, 58, 60, 62, 64 preferably extend through the outer skin 42, the post 48 and the inner skin 46. The fasteners 54, 56, 58, 60, 62, 64 are required in the configuration illustrated in FIG. 4C (where no adhesive is used), but may be optionally used in the configurations illustrated in FIGS. 4, 4A and 4B (where adhesive is used). The fasteners 58, 60, 62, 64 are spaced at predetermined intervals, such as for example twelve inches apart on centers, however, it is to be understood that other spacings may be used. The lowermost fasteners 54, 56 may also extend through the scuff plate 52. Fastener 54 is provided proximate the bottom of the post 48 and fastener 56 is provided proximate the top of the scuff plate 52.

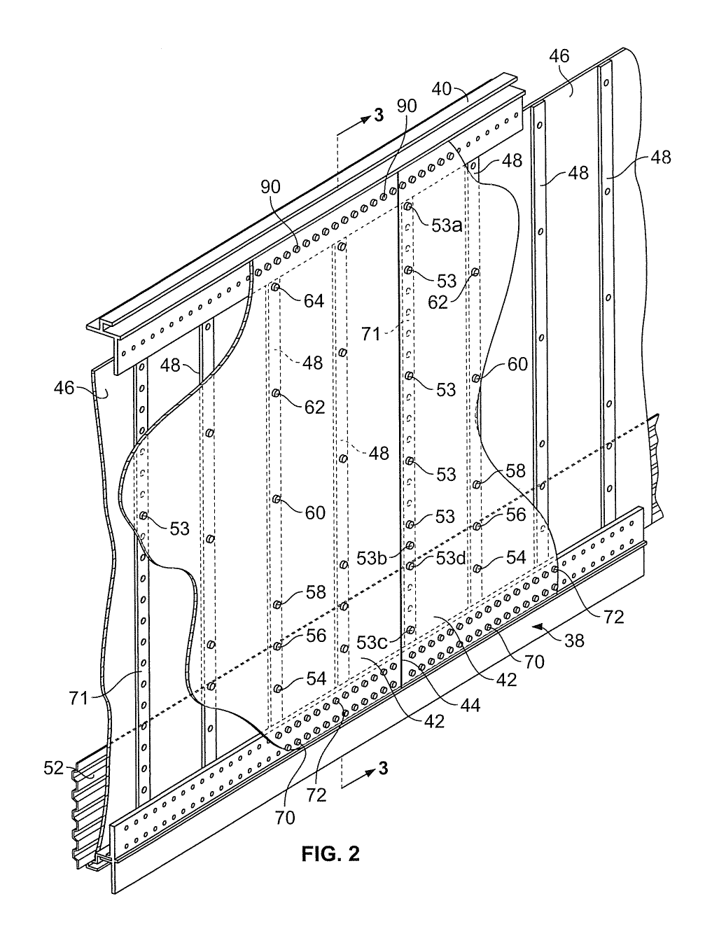

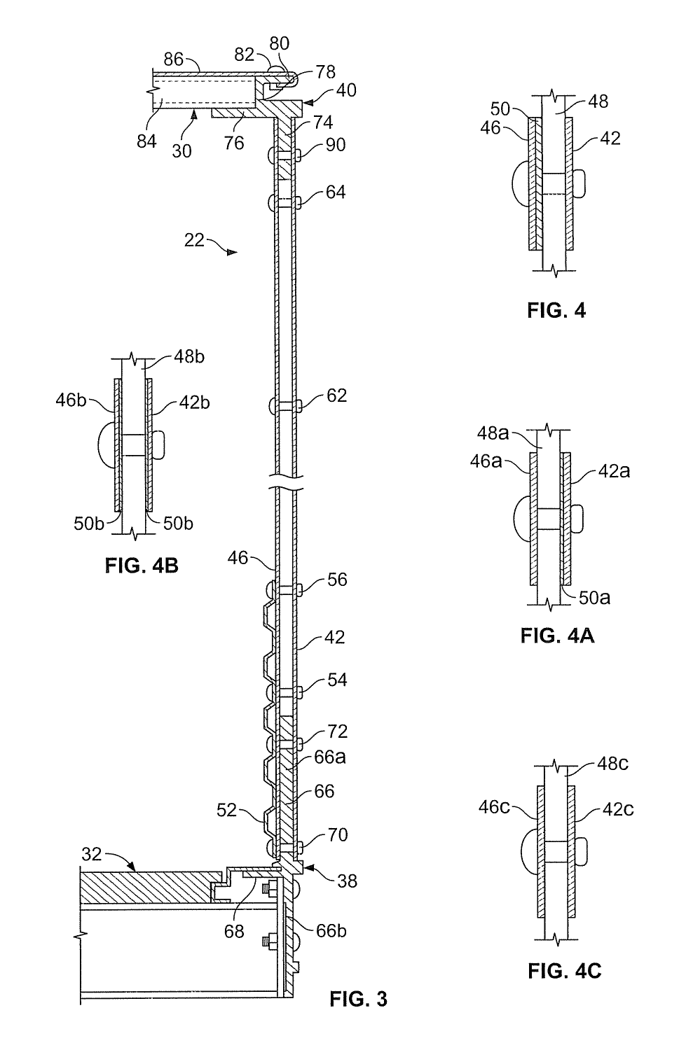

As best illustrated in FIG. 3, the bottom rail 38 which is used to connect the sidewall 22 to the floor structure 32 includes a vertical portion 66 and a horizontal portion 68 which is generally perpendicular to the vertical portion 66. The horizontal portion 68 is located at approximately the midpoint of the vertical portion 66, thereby dividing the vertical portion 66 into an upper vertical portion 66a and a lower vertical portion 66b. The upper vertical portion 66a is positioned between the outer skins 42 and the inner skins 46 along the length of the sidewall 22. The upper vertical portion 66a has a predetermined height such that the upper vertical portion 66a extends a predetermined distance upwardly between the outer and inner skins 42, 46. The upper vertical portion 66a spans the width between the outer and inner skins 42, 46 and therefore has the same width as the posts 48, 71. The bottom ends of the posts 48, 71 face the upper end of the upper vertical portion 66a, such that the bottom ends of the posts 48, 71 sit on top of the upper end of the upper vertical portion 66a (as illustrated in FIGS. 2 and 3), or such that a gap is provided therebetween; the gap may be provided for tolerance purposes. The horizontal portion 68 and the lower vertical portion 66b are attached to the floor structure 32 by suitable means. The construction of the bottom rail 38 can be varied for its connection to the floor structure 32 and the embodiment shown in the drawings is merely exemplary.

Two rows of spaced apart fasteners 70, 72, preferably rivets, are provided along the length of the sidewall 22. The first row of fasteners 70 are provided proximate the lower end of the upper vertical portion 66a of the bottom rail 38 and extend through the respective outer skin 42, the bottom rail 38, the respective inner skin 46 and the scuff plate 52. The fasteners 70 are preferably positioned apart from each other two inches on centers, however other spacings may be provided. The second row of fasteners 72 are provided proximate the upper end of the upper vertical portion 66a and extend through the respective outer skin 42, the bottom rail 38, the respective inner skin 46 and the scuff plate 52. The fasteners 72 are preferably positioned apart from each other two inches on centers, however other spacings may be provided. At least one row fasteners is provided. Fasteners 53c and 54, which extend through the respective outer skin 42, the respective posts 48, 71, the respective inner skins 46 and the scuff plate 52, prevent the bottom ends of the respective posts 48, 71 from moving relative to the bottom rail 38.

The top rail 40 which is used to connect the sidewall 22 to the roof structure 30 is formed of a first vertical wall 74, a second wall 76 which is perpendicular to the first vertical wall 74, a third wall 78 which is perpendicular to the second wall 76 and parallel to the first wall 74, and a fourth wall 80 which is perpendicular to the third wall 78 and parallel to the second wall 76. The first vertical wall 74 is positioned between the outer skins 42 and the inner skins 46 along the length of the sidewall 22. The vertical wall 74 has a predetermined height and extends a predetermined distance downwardly between the outer and inner skins 42, 46. The vertical wall 74 spans the width between the outer and inner skins 42, 46 and therefore has the same width as the posts 48, 71. The upper ends of the posts 48, 71 face the lower end of the vertical wall 74 such that the upper ends of the posts 48, 71 may abut against the lower end of the vertical wall 74 (as illustrated in FIGS. 2 and 3), or such that a gap is provided between the upper ends of the posts 48, 71 and the lower end of the vertical wall 74; the gap may be provided for tolerance purposes. The second wall 76 extends inwardly toward the interior of the trailer 20 and has a plurality of spaced apart apertures provided therethrough for acceptance of fasteners (not shown), such as rivets, as described herein. The fourth wall 80 extends outwardly from the interior of the trailer 20. The fourth wall 80 has a plurality of spaced apart apertures provided therethrough for acceptance of fasteners 82, such as rivets, as described herein.

The roof structure 30 is formed of a plurality of roof bows 84 which span the width of the trailer 20 and a flat roof sheet 86 which spans the width and length of the trailer 20. The roof bows 84 are provided at predetermined spaced apart positions along the length of the trailer 20. Each roof bow 84 sits on the second wall 76 and is secured thereto by fasteners, such as rivets. The roof sheet 86 is attached to the top surface of the roof bows 84 by structural adhesive and wraps around the fourth wall 80 of the top rail 40. The roof sheet 86 is attached to the fourth wall 80 of the top rail 40 by fasteners 82, such as rivets. The roof sheet 48 is formed of a metal sheet or a strong, reinforced material, such as KEMLITE® material or BULITEX® material or the like.

A row of spaced apart fasteners 90, preferably rivets, are provided along the length of the sidewall 22 and extend through the respective outer skin 42, the first vertical wall 74 of the top rail 40 and the respective inner skin 46. The fasteners 90 are preferably positioned apart from each other two inches on centers, but other spacings may be provided. More than a single row may be provided. Fasteners 53a and 64, which extend through the respective outer skins 42, the respective posts 48, 71 and the respective inner skins 46, prevent the top ends of the respective posts 48, 71 from moving relative to the top rail 40.

As a result of the construction, the upper vertical portion 66a of the bottom rail 38 and the first vertical wall 74 of the top rail 40 form a portion of the sidewall 22. Because the bottom rail 38 and the top rail 40 are positioned between the outer and inner skins 42, 46, the interior dimension of the trailer 20 is increased over the prior art which provided the bottom and top rails on the interior of the sidewall.

In the event of an interior impact, the inner skins 46 of the panels 23 form the compression side of the sidewall 22 and the outer skins 42 of the panels 23 form the tension side of the sidewall 22. In the preferred embodiment, as illustrated in FIGS. 4, 5 and 6, structural adhesive is not used to bond the outer skins 42 to the posts 48, 71 so that if repair becomes necessary, the fasteners 53, 53a, 53b, 53c, 53d, 54, 56, 58, 60, 62, 64, 70, 72, 78 can be easily removed, such as by drilling same out, to remove the damaged outer skin 42 and replace same with a new outer skin. In the event of an exterior impact, the inner skins 46 form the tension side of the sidewall 22 and the outer skins 42 form the compression side of the sidewall 22.

As a result of the construction, the fasteners 54, 56, 58, 60, 62, 64, 70, 72, 78 are in double shear. This allows for fewer fasteners to be used than in the prior art.

A suitable adhesive that can be used in this first embodiment is a one-part or two-part structural adhesive such as epoxy, acrylic, urethane and the like. Such structural adhesives are sold, for example, under the tradenames SIKAFAST and PLEXUS.

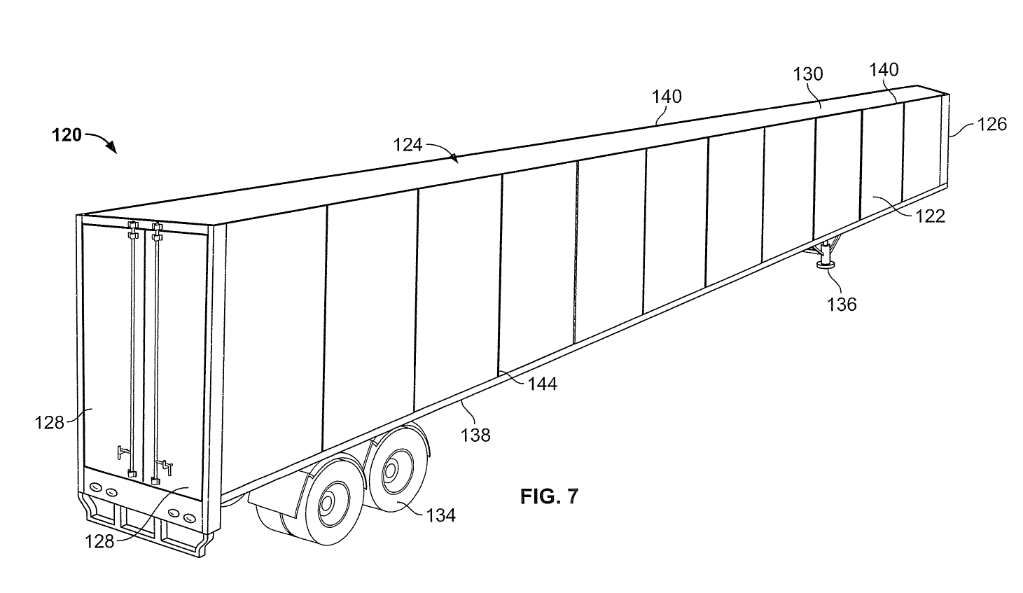

Attention is invited to the second embodiment of the trailer 120 shown in FIGS. 7-11. The trailer 120 includes a body 124 formed from a pair of rectangular sidewalls 122, a front wall 126, rear frame and doors 128, a roof structure 130, and a floor structure 132. The rear of the floor structure 132 is supported by a conventional rear undercarriage assembly 134 and the front of the floor structure 132 has a landing gear 136 secured thereunder. The floor structure 132 and a lower portion of each sidewall 122 are secured to a respective bottom rail 138 which extends the length of the trailer 120. The bottom rails 138 are preferably formed of aluminum, which may be extruded. The roof structure 130 and an upper portion of each sidewall 122 are secured to a respective top rail 140 which extends the length of the trailer 120. The top rails 140 are preferably formed of aluminum, which may be extruded. The trailer 120 can be connected to a tractor (not shown) by conventional means, such as a fifth wheel assembly.

The sidewalls 122 are formed of a plurality of panels 123 which are identical to one another in configuration and, as such, only one of the panels 123 is described. Each panel 123 has an outer skin 142 and an inner skin 146. Adjacent panels 123 of the sidewall 122 are jointed together at a joint 144. Preferably, each skin 142 and 146 is four (4) feet in length, but may vary in length therefrom. Each outer skin 142 and each inner skin 146 can be formed of a thin metal skin, preferably formed of aluminum or steel, and can range in thickness (such as 0.013 to 0.026 for steel skins and 0.050 inches for aluminum skins) or may be a thin composite material and can range in thickness (such as 0.026); other suitable or like materials may also be used. It is to be understood that other lengths or thicknesses may be used as required by the application.

Each panel 123 further includes a plurality of posts 148 mounted between the outer and inner skins 142 and 146. Each post 148 extends along the height of the respective sidewall 122 between the bottom and top rails 138, 140 and spans the width between the outer and inner skins 142, 146. Adjacent posts 148 are preferably spaced-apart from one another such that voids are provided between adjacent posts 148 and the outer and inner skins 142, 146. The posts 148 are preferably formed of a metal material, such as aluminum or steel. Preferably, as illustrated in FIG. 10, the outer skins 142 are attached to the post 148 by structural adhesive 149, and the inner skins 146 are attached to the post 148 by structural adhesive 150.

As shown, each outer and inner skin 142 and 146 overlaps three (3) posts 148, but it is to be understood that outer and inner skins 142 and 146 can overlap more or fewer posts 148. The posts 148 provide all of the structural integrity for the panels 123 such that it is unnecessary, and even undesirable, to include any type of core material within the voids formed between adjacent posts 148 as it will add weight to the panels 123 and the sidewalls 122. First end portions 159a, 161a of the outer and inner skins 142, 146 extend beyond one of the posts 148 most proximate to a first end 163 of the panel 123; second end portions 159b, 161b of the outer and inner skins 142, 146 extend beyond another one of the posts 148 most proximate to a second end 165 of the panel 123.

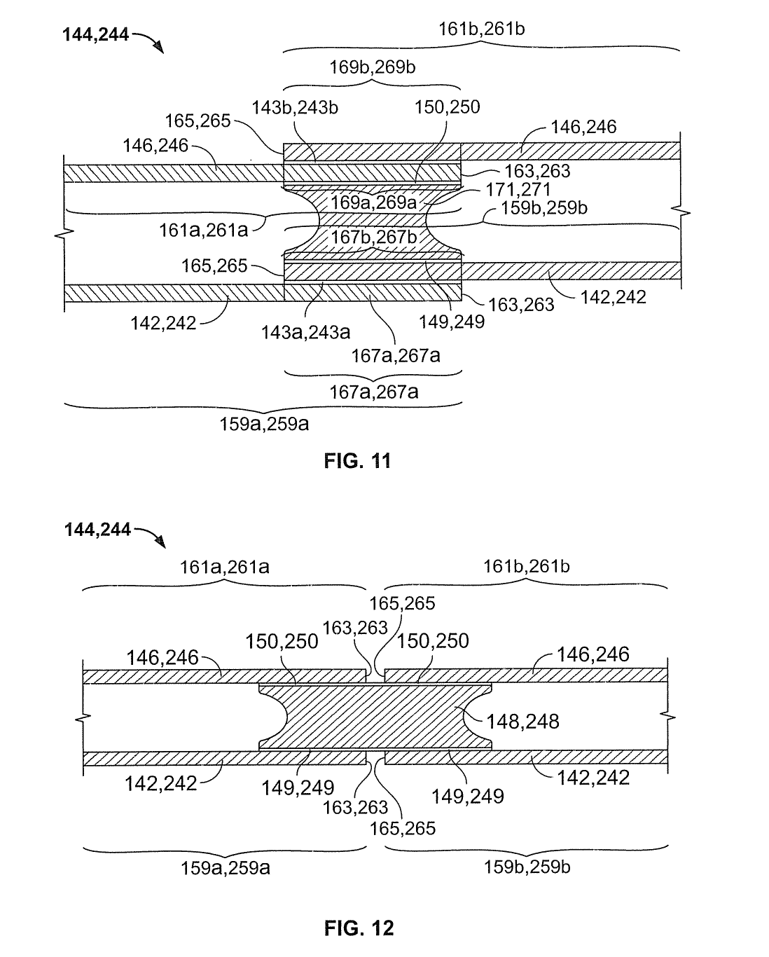

As shown in the second embodiment, and specifically FIG. 11, the adjacent panels 123 are joined together at joints 144, which are lap joints. At the joints 144, portions 167a of the first end portions 159a of the outer skins 142 of one panel 123 overlap portions 167b of the second end portions 159b of the outer skins 142 of an adjacent panel 123, and portions 169a of the first end portions 161a of the inner skins 146 of the one panel 123 overlap portions 169b of the second end portions 161b of the inner skins 146 of the adjacent panel 123. A post 171, which is preferably identical to the posts 148, is positioned between the overlapping portions 167a, 167b of the outer skins 142 and the overlapping portions 169a, 169b of the inner skins 146. Preferably, the post 171 is attached to one of the overlap portions 169a, 169b of the inner skins 146 by a structural adhesive 150, and to one of the overlap portions 167a, 167b of the outer skins 142 by a structural adhesive 149. Also, the overlap portions 167a, 167b of the outer skins 142 are preferably attached to one another by a structural adhesive 143a and the overlap portions 169a, 169b of the inner skins 146 are preferably attached to one another by a structural adhesive 143b. While not illustrated and not preferred, it is to be understood that the joint 144 could be formed without use of one of the structural adhesives 149, 150.

Alternatively, as shown in FIG. 12, the posts 171 can be made wider and the end 163 of the first end portion 159a of one of the outer skins 142 can face the end 165 of the second end portion 159b of the adjacent outer skin 142, whether separated from (as illustrated), or abutting against, one another, with each outer skin 142 being attached to the post 171 at the joint 144; and the end 163 of the first end portion 161a of one of the inner skins 146 can face the end 165 of the second end portion 161b of the adjacent inner skin 146, whether separated from (as illustrated), or abutting against, one another, with each inner skin 146 being attached to the post 171 at the joint 144. Preferably, the post 171 is attached to each of the end portions 161a, 161b of the inner skins 146 by a structural adhesive 150, and to each of the end portions 159a, 159b of the outer skins 142 by a structural adhesive 149. While not illustrated and not preferred, it is to be understood that the joint 144 could be formed without use of one of the structural adhesives 149, 150.

Another alternative for forming the joints 144 between adjacent inner and outer skins 142 and 146 is shown and herein discussed in further detail with regard to FIGS. 17-20. If desired, some or all of the end portions 159a, 159b; 161a, 161b of the outer skins 142 and/or the inner skins 146 may be stepped by suitable means.

A conventional scuff plate 152 is proximate to and may abut against the inner surface of the inner skins 146. The scuff plate 152 may be formed of metal, wood, a composite material, or any other suitable material. The scuff plate 152 is attached to the inner skins 146 by structural adhesive.

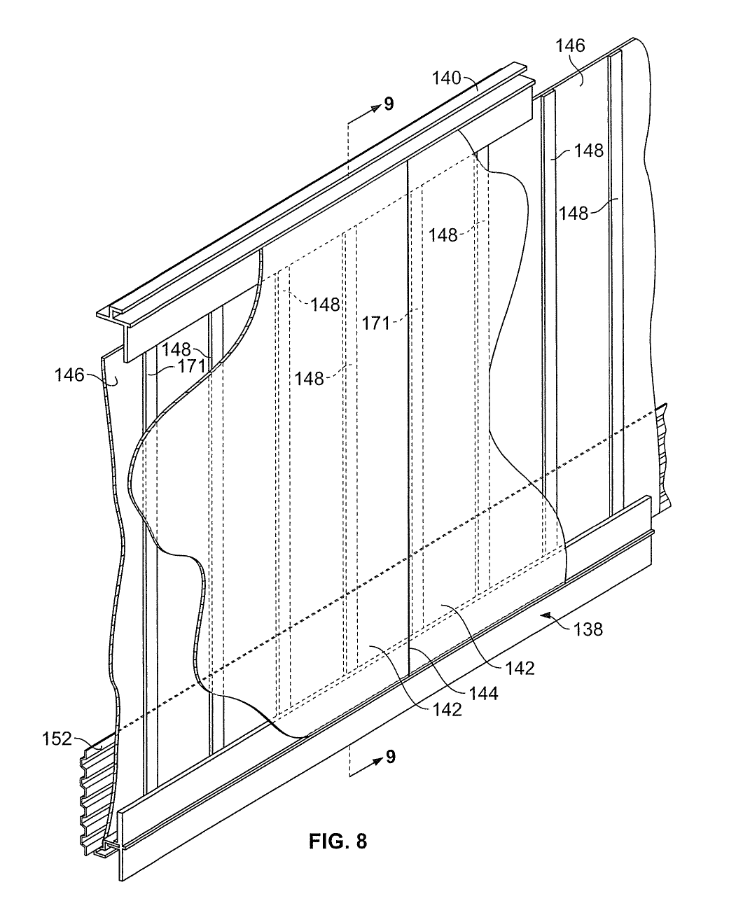

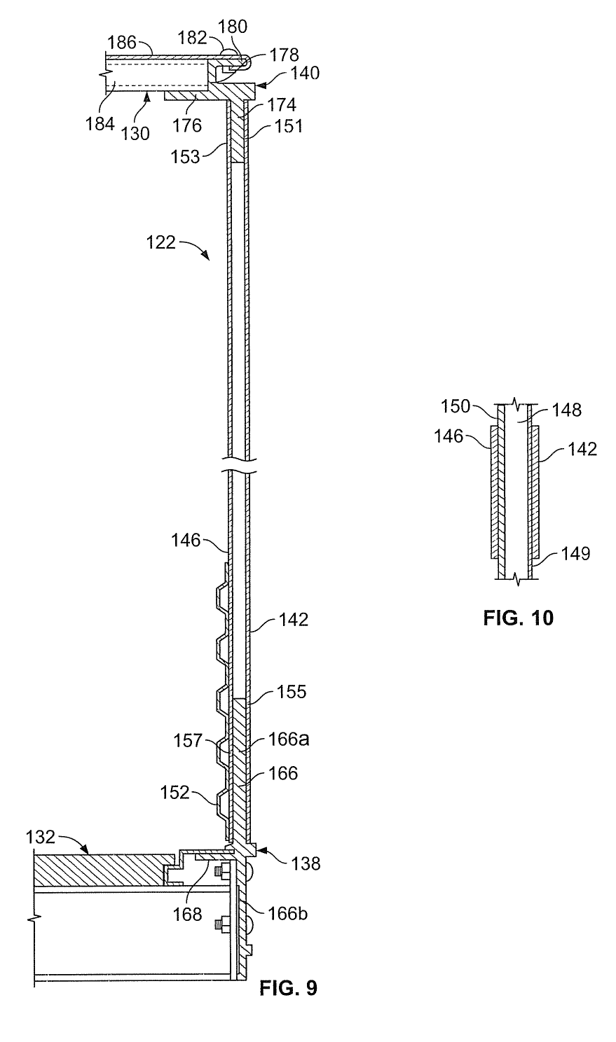

As best illustrated in FIG. 9, the bottom rail 138 which is used to connect the sidewall 122 to the floor structure 132 includes a vertical portion 166 and a horizontal portion 168 which is generally perpendicular to the vertical portion 166. The horizontal portion 168 is located at approximately the midpoint of the vertical portion 166, thereby dividing the vertical portion 166 into an upper vertical portion 166a and a lower vertical portion 166b. The upper vertical portion 166a is positioned between the outer skins 142 and the inner skins 146 along the length of the sidewall 122 and bonded thereto by structural adhesive 151 and 153. Because the bottom rail 138 is clean aluminum, this aids in bonding of the outer skins 142 and the inner skins 146 with the bottom rail 138. The upper vertical portion 166a has a predetermined height such that the upper vertical portion 166a extends a predetermined distance upwardly between the outer and inner skins 142, 146. The upper vertical portion 166a spans the width between the outer and inner skins 142, 146 and therefore has the same width as the posts 148, 171. The bottom ends of the posts 148, 171 face the upper end of the upper vertical portion 166a, such that the bottom ends of the posts 148, 171 sit on top of the upper end of the upper vertical portion 166a (as illustrated in FIGS. 8 and 9), or such that a gap is provided therebetween; the gap may be provided for tolerance purposes. The horizontal portion 168 and the lower vertical portion 166b are attached to the floor structure 132 by suitable means. The construction of the bottom rail 138 can be varied for its connection to the floor structure 132 and the embodiment shown in the drawings is merely exemplary.

The top rail 140 which is used to connect the sidewall 122 to the roof structure 130 is formed of a first vertical wall 174, a second wall 176 which is perpendicular to the first vertical wall 174, a third wall 178 which is perpendicular to the second wall 176 and parallel to the first wall 174, and a fourth wall 180 which is perpendicular to the third wall 178 and parallel to the second wall 176. The first vertical wall 174 is positioned between the outer skins 142 and the inner skins 146 along the length of the sidewall 122 and is bonded thereto by structural adhesive 155, 157. Because the top rail 140 is clean aluminum, this aids in bonding of the outer skins 142 and the inner skins 146 with the top rail 140. The vertical wall 174 has a predetermined height and extends a predetermined distance downwardly between the inner and outer skins 142, 146. The vertical wall 174 spans the width between the outer and inner skins 142, 146 and therefore has the same width as the posts 148, 171. The upper ends of the posts 148, 171 face the lower end of the vertical wall 174 such that the upper ends of the posts 148, 171 may abut against the lower end of the vertical wall 174 (as illustrated in FIGS. 8 and 9), or such that a gap is provided between the upper ends of the posts 148, 171 and the lower end of the vertical wall 174; the gap may be provided for tolerance purposes. The second wall 176 extends inwardly toward the interior of the trailer 120 and has a plurality of spaced apart apertures provided therethrough for acceptance of fasteners (not shown), such as rivets, as described herein. The fourth wall 180 extends outwardly from the interior of the trailer 120. The fourth wall 180 has a plurality of spaced apart apertures provided therethrough for acceptance of fasteners 182, such as rivets, as described herein.

The roof structure 130 is formed of a plurality of roof bows 184 which span the width of the trailer 120 and a flat roof sheet 186 which spans the width and length of the trailer 120. The roof bows 184 are provided at predetermined spaced apart positions along the length of the trailer 120. Each roof bow 184 sits on the second wall 176 and is secured thereto by fasteners (not shown), such as rivets. The roof sheet 186 is attached to the top surface of the roof bows 184 by structural adhesive and wraps around the fourth wall 180 of the top rail 140. The roof sheet 186 is attached to the fourth wall 180 of the top rail 140 by fasteners 180, such as rivets. The roof sheet 148 is formed of a metal sheet or a strong, reinforced material, such as KEMLITE® material or BULITEX® material or the like.

As a result of the construction, the upper vertical portion 166a of the bottom rail 138 and the first vertical wall 174 of the top rail 140 form a portion of the sidewall 122. Because the bottom rail 138 and the top rail 140 are positioned between the outer and inner skins 142, 146, the interior dimension of the trailer 120 is increased over the prior art which provided the bottom and top rails on the interior of the sidewall.

As a result of the construction of the trailer 120, the fasteners used in the sidewall 22 construction of the first embodiment have been eliminated and the sidewall 122 is formed by bonding using structural adhesive. If desired, fasteners, such as those provided in the first embodiment, can be used for shear. It is to be understood that such fasteners are not necessary for this second embodiment.

A suitable adhesive that can be used in this second embodiment is a one-part or two-part structural adhesive such as epoxy, acrylic, urethane and the like. Such structural adhesives are sold, for example, under the tradenames SIKAFAST and PLEXUS.

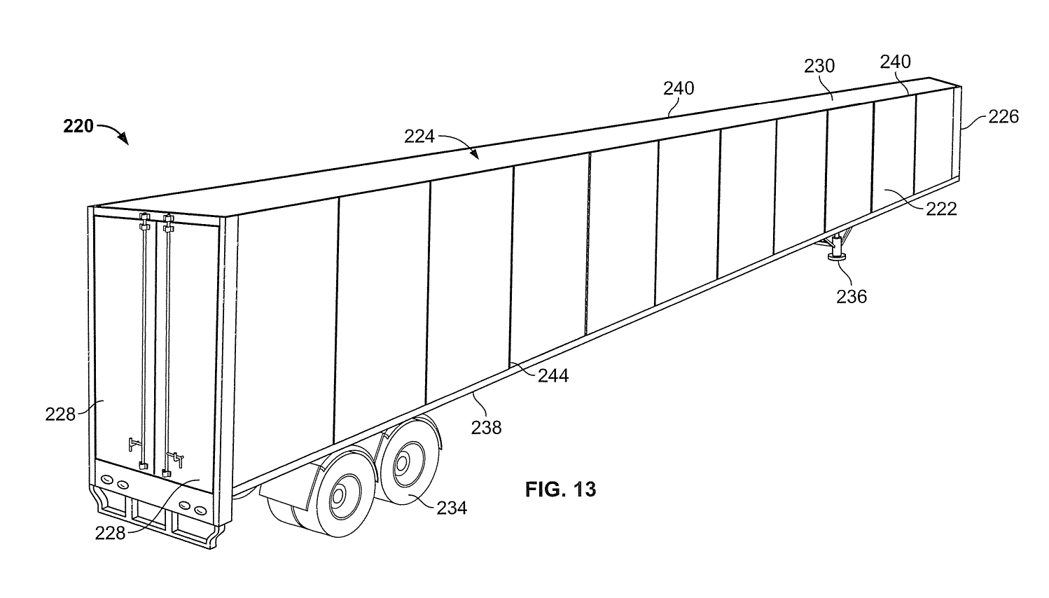

Attention is invited to the third embodiment of the trailer 220 shown in FIGS. 13-16. The trailer 220 includes a body 224 formed from a pair of rectangular sidewalls 222, a front wall 226, rear frame and doors 228, a roof structure 230, and a floor structure 232. The rear of the floor structure 232 is supported by a conventional rear undercarriage assembly 234 and the front of the floor structure 232 has a landing gear 236 secured thereunder. The floor structure 232 and a lower portion of each sidewall 222 are secured to a respective bottom rail 238 which extends the length of the trailer 220. The bottom rails 238 are preferably formed of aluminum, which may be extruded. The roof structure 230 and an upper portion of each sidewall 222 are secured to a respective top rail 240 which extends the length of the trailer 220. The top rails 240 are preferably formed of aluminum, which may be extruded. The trailer 220 can be connected to a tractor (not shown) by conventional means, such as a fifth wheel assembly.

The sidewalls 222 are formed of a plurality of panels 223 which are identical to one another in configuration and, as such, only one of the panels 223 is described. Each panel 223 has an outer skin 242 and an inner skin 246. Adjacent panels 223 of the sidewall 222 are joined together at a joint 244. Preferably, each skin 242 aid 246 is four (4) feet in length, but may vary in length therefrom. Each outer skin 242 and each inner skin 246 can be formed of a thin metal skin, preferably formed of aluminum or steel, and can range in thickness (such as 0.013 to 0.026 for steel skins and 0.050 inches for aluminum skins) or may be a thin composite material and can range in thickness (such as 0.026); other suitable or like materials may also be used. It is to be understood that other lengths or thicknesses may be used as required by the application.

Each panel 223 further includes a plurality of posts 248 mounted between the outer and inner skins 242 and 246. Each post 248 extends along the height of the respective sidewall 222 between the bottom and top rails 238, 240 and spans the width between the outer and inner skins 242, 246. Adjacent posts 248 are preferably spaced-apart from one another such that voids are provided between adjacent posts 248 and the outer and inner skins 242, 246. The posts 248 are preferably formed of a metal material, such as aluminum or steel. Preferably, as illustrated in FIG. 16, the outer skins 242 are attached to the post 248 by structural adhesive 249, and the inner skins 246 are attached to the post 248 by structural adhesive 250.

As shown, each outer and inner skin 242 and 246 overlaps three (3) posts 248, but it is to be understood that outer and inner skins 242 and 246 can overlap more or fewer posts 248. The posts 248 provide all of the structural integrity for the panels 223 such that it is unnecessary, and even undesirable, to include any type of core material within the voids formed between adjacent posts 248 as it will add weight to the panels 223 and the sidewalls 222. First end portions 259a, 261a of the outer and inner skins 242, 246 extend beyond one of the posts 248 most proximate to a first end 263 of the panel 223; second end portions 259b, 261b of the outer and inner skins 242, 246 extend beyond another one of the posts 248 most proximate to a second end 265 of the panel 223.

As shown in the third embodiment, and specifically FIG. 11, the adjacent panels 223 are joined together at joints 244, which are lap joints. At the joints 244, portions 267a of the first end portions 259a of the outer skins 242 of one panel 223 overlap portions 267b of the second end portions 259b of the outer skins 242 of an adjacent panel 223, and portions 269a of the first end portions 261a of the inner skins 246 of the one panel 223 overlap portions 269b of the second end portions 261b of the inner skins 246 of the adjacent panel 223. A post 271, which is preferably identical to the posts 248, is positioned between the overlapping portions 267a, 267b of the outer skins 242 and the overlapping portions 269a, 269b of the inner skins 246. Preferably, the post 271 is attached to one of the overlap portions 269a, 269b of the inner skins 246 by a structural adhesive 250, and to one of the overlap portions 267a, 267b of the outer skins 242 by a structural adhesive 249. Also, the overlap portions 267a, 267b of the outer skins 242 are preferably attached to one another by a structural adhesive 243a and the overlap portions 269a, 269b of the inner skins 246 are preferably attached to one another by a structural adhesive 243b. While not illustrated and not preferred, it is to be understood that the joint 244 could be formed without use of one of the structural adhesives 249, 250.

Alternatively, as shown in FIG. 12, the posts 271 can be made wider and the end 263 of the first end portion 259a of the adjacent outer skins 242 can face the end 265 of the second end portion 259b of the adjacent outer skin 242, whether separated from (as illustrated), or abutting against, one another, with each outer skin 242 being attached to the post 271 at the joint 244; and the end 263 of the first end portion 261a of one of the inner skins 246 can face the end 265 of the second end portion 261b of the adjacent inner skin 246, whether separated from (as illustrated), or abutting against, one another, with each inner skin 246 being attached to the post 271 at the joint 244. If desired, some or all of the end portions 259a, 259b; 261a, 261b of the outer skins 242 and/or the inner skins 246 may be stepped by suitable means. Preferably, the post 271 is attached to each of the end portions 261a, 261b of the inner skins 246 by a structural adhesive 250, and to each of the end portions 259a, 259b of the outer skins 242 by a structural adhesive 249. While not illustrated and not preferred, it is to be understood that the joint 244 could be formed without use of one of the structural adhesives 249, 250.

Another alternative for forming the joints 244 between adjacent outer and inner skins 242 and 246 is shown and herein discussed in further detail with regard to FIGS. 17-20.

A conventional scuff plate 252 is proximate to and may abut against the inner surface of the inner skins 246. The scuff plate 252 may be formed of metal, wood, a composite material, or any other suitable material. The scuff plate 252 is attached to the inner skins 246 by structural adhesive.

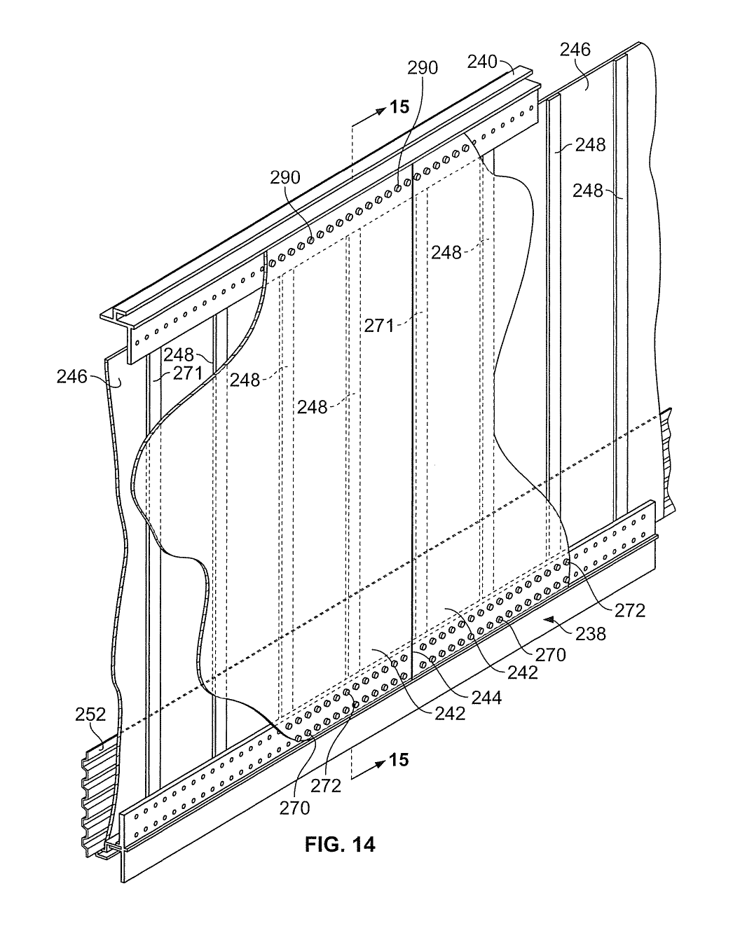

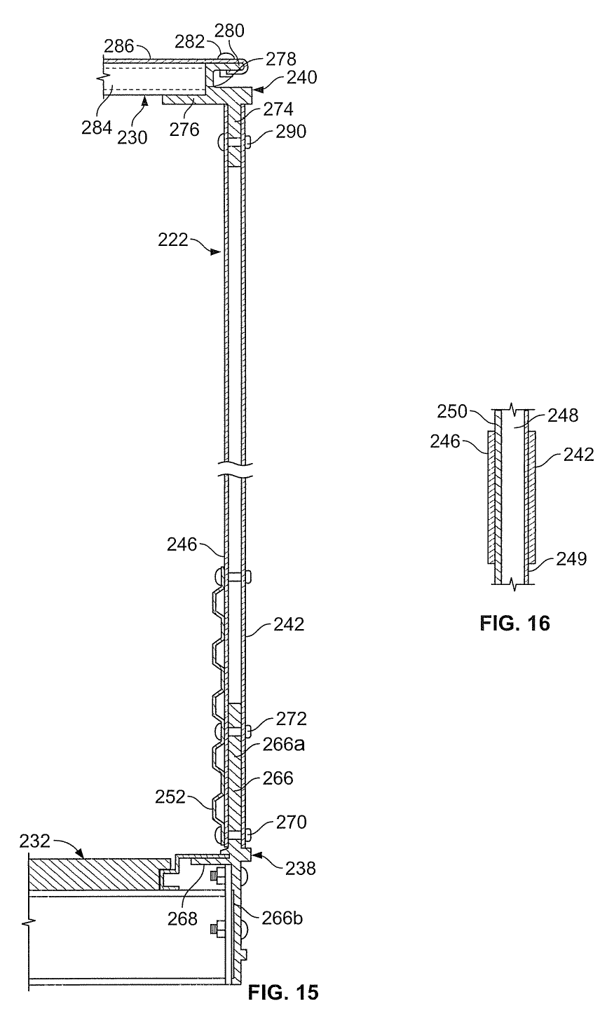

The top rail 240 which is used to connect the sidewall 222 to the roof structure 230 is formed of a first vertical wall 274, a second wall 276 which is perpendicular to the first vertical wall 274, a third wall 278 which is perpendicular to the second wall 276 and parallel to the first wall 274, and a fourth wall 280 which is perpendicular to the third wall 278 and parallel to the second wall 276. The first vertical wall 274 is positioned between the outer skins 242 and the inner skins 246 along the length of the sidewall 222. The vertical wall 274 has a predetermined height and extends a predetermined distance downwardly between the inner and outer skins 242, 246. The vertical wall 274 spans the width between the outer and inner skins 242, 246 and therefore has the same width as the posts 248, 271. If desired, the outer and inner skins 242, 246 may be adhesively bonded to the vertical wall 274. The upper ends of the posts 248, 271 face the lower end of the vertical wall 274 (as illustrated in FIGS. 14 and 15), or such that a gap is provided between the upper ends of the posts 248, 271 and the lower end of the vertical wall 274; the gap may be provided for tolerance purposes. The second wall 276 extends inwardly toward the interior of the trailer 220 and has a plurality of spaced apart apertures provided therethrough for acceptance of fasteners (not shown), such as rivets, as described herein. The fourth wall 280 extends outwardly from the interior of the trailer 220. The fourth wall 280 has a plurality of spaced apart apertures provided therethrough for acceptance of fasteners 282, such as rivets, as described herein.

The roof structure 230 is formed of a plurality of roof bows 284 which span the width of the trailer 220 and a flat roof sheet 286 which spans the width and length of the trailer 220. The roof bows 284 are provided at predetermined spaced apart positions along the length of the trailer 220. Each roof bow 284 sits on the second wall 276 and is secured thereto by fasteners (not shown), such as rivets. The roof sheet 286 is attached to the top surface of the roof bows 284 by structural adhesive and wraps around the fourth wall 280 of the top rail 240. The roof sheet 286 is attached to the fourth wall 280 of the top rail 240 by fasteners 282, such as rivets. The roof sheet 248 is formed of a metal sheet or a strong, reinforced material, such as KEMLITE® material or BULITEX® material or the like.

A row of spaced apart fasteners 290, preferably rivets, are provided along the length of the sidewall 222 and extend through the respective outer skin 242, the first vertical wall 274 of the top rail 240 and the respective inner skin 246. The fasteners 290 are preferably positioned apart from each other two inches on centers, but other spacings may be provided. More than a single row may be provided.

As a result of the construction, the upper vertical portion 266a of the bottom rail 238 and the first vertical wall 274 of the top rail 240 form a portion of the sidewall 222. Because the bottom rail 238 and the top rail 240 are positioned between the outer and inner skins 242, 246, the interior dimension of the trailer 220 is increased over the prior art which provided the bottom and top rails on the interior of the sidewall.

As best illustrated in FIG. 15, the bottom rail 238 which is used to connect the sidewall 222 to the floor structure 232 includes a vertical portion 266 and a horizontal portion 268 which is generally perpendicular to the vertical portion 266. The horizontal portion 268 is located at approximately the midpoint of the vertical portion 266, thereby dividing the vertical portion 266 into an upper vertical portion 266a and a lower vertical portion 266b. The upper vertical portion 266a is positioned between the outer skins 242 and the inner skins 246 along the length of the sidewall 222. If desired, the outer skins 242 and the inner skins 246 may be adhesively bonded to the upper vertical portion 266a. The upper vertical portion 266a has a predetermined height such that the upper vertical portion 266a extends a predetermined distance upwardly between the outer and inner skins 242, 246. The upper vertical portion 266a spans the width between the outer and inner skins 242, 246 and therefore has the same width as the posts 248, 271. The bottom ends of the posts 248, 271 face the upper end of the upper vertical portion 266a, such that the bottom ends of the posts 248, 271 sit on top of the upper end of the upper vertical portion 266a (as illustrated in FIGS. 14 and 15), or such that a gap is provided therebetween; the gap may be provided for tolerance purposes. The horizontal portion 268 and the lower vertical portion 266b are attached to the floor structure 232 by suitable means. The construction of the bottom rail 238 can be varied for its connection to the floor structure 232 and the embodiment shown in the drawings is merely exemplary.

Two rows of spaced apart fasteners 270, 272, preferably rivets, are provided along the length of the sidewall 222. The first row of fasteners 270 are provided proximate the lower end of the upper vertical portion 266a of the bottom rail 238 and extend through the respective outer skin 242, the bottom rail 238, the respective inner skin 246 and the scuff plate 252. The fasteners 270 are preferably positioned apart from each other two inches on centers, however other spacings may be provided. The second row of fasteners 272 are provided proximate the upper end of the upper vertical portion 266a and extend through the respective outer skin 242, the bottom rail 238, the respective inner skin 246 and the scuff plate 252. The fasteners 272 are preferably positioned apart from each other two inches on centers, however other spacings may be provided. At least one row fasteners is provided.

As a result of the construction of the trailer 220, many of the fasteners used in the sidewall 22 construction of the first embodiment have been eliminated and most of the sidewall 222 is formed by bonding using structural adhesive. If desired, a few shear rivets may be used.

A suitable adhesive that can be used in this third embodiment is a one-part or two-part structural adhesive such as epoxy, acrylic, urethane and the like. Such structural adhesives are sold, for example, under the tradenames SIKAFAST and PLEXUS.

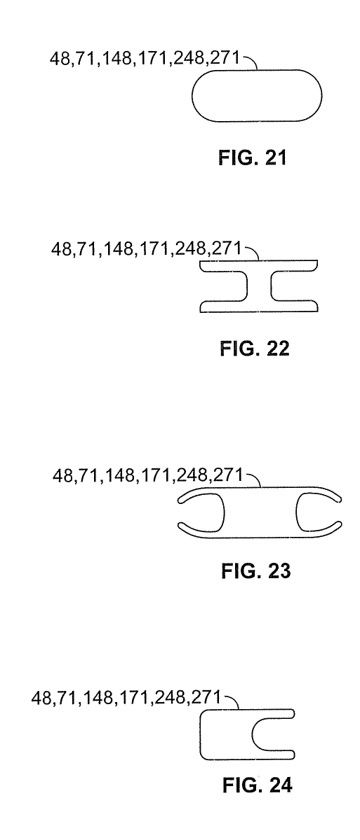

In each embodiment, the posts 48, 71, 148, 171, 248, 271 can be formed as shown rectangular in cross-section as shown in FIGS. 2, 8 and 14, having inwardly scalloped edges 400 in cross-section as shown in FIGS. 5, 6, 11, 12 and 17-20, being oblong in cross-section (FIG. 21), I-beam shaped in cross-section (FIG. 22), I-beam shaped with curved ends in cross-section (FIG. 23), generally C-shaped in cross-section (FIG. 24), or may take other forms not shown. If rectangular, the posts 48, 71, 148, 171, 248, 271 preferably has a width (the distance between the outer and inner skins 42, 46; 142, 146; 242, 246) which is less than the traverse dimension of the post 48, 71, 148, 171, 248, 271.

A preferred spacing for the posts 48, 71, 148, 171, 248, 271 is one (1) foot intervals along the length of the sidewall 22, 122 and 222 and a preferred dimension of each post 48, 71, 148, 171, 248, 271 is 0.25 inches by one (1) inch. It is to be understood that other quantities, spacing and dimensions may be used depending on the application. For example, the posts 48, 71, 148, 171, 248, 271 may vary in width or thickness to vary the stiffness of the sidewall 22, 122, 222.

As shown in FIGS. 17 and 18, alternate joints for joining the skins 42 and 46 are provided.

In FIG. 17, a plate 402 is provided which extends between the adjacent ends 63, 65 of the outer skins 42, and a plate 404, which may be a logistics plate, is provided which extends between the adjacent ends 63, 65 of the inner skins 46.

In this joint 44, the ends 63, 65 of the outer skins 42 and the ends 63, 65 of the inner skins 46 are spaced apart from each other. The plate 402 has flat end sections 406, 408 and a curved intermediate section 410 therebetween. The intermediate section 410 curves outwardly from the interior of the trailer 20. The flat end sections 406, 408 sit against the outer surfaces of the respective adjacent outer skins 42, at the end portions 59a, 59b thereof, and the intermediate section 410 spans the distance between the adjacent ends 63, 65 of the outer skins 42. The intermediate section 410 is preferably curved or bulged outwardly in order to increase a size of the gap provided between the ends 63, 65 of the respective adjacent outer skins 42. If desired, the intermediate section 410 may transition to a flat (not shown) or to a closed end at the top and/or bottom ends of the plate 402 for aiding in connection to the top and bottom rails 30 and 38.

The plate 404 has flat end sections 412, 414 and an intermediate section 416 therebetween. The intermediate section 416 has end portions 418, 420 which taper inwardly from the flat end sections 412, 414 toward the interior of the trailer 20 and a flat middle portion 422 extending therebetween. The middle portion 422 is not flush with the inner surfaces of the inner skins 46. The flat end sections 412, 414 sit against the outer surfaces of the respective adjacent inner skins 46, at the end portions 61a, 61b thereof, and the intermediate section 416 spans the distance between the adjacent ends 63, 65 of the inner skins 46. The intermediate section 416 may have a plurality of logistics apertures 417 provided therethrough to provide access to the gap provided between the adjacent ends 63, 65 of the outer and inner skins 42, 46, if desired.

A post 71 is positioned between the inner surface of the end portion 59a of the outer skin 42 and the outer surface of the end section 412. A plurality of spaced-apart fasteners 424, such as rivets, extend through the end section 406 of the plate 402, the end portion 59a of the outer skin 42, the post 71, the end section 412 of the plate 404, and the end portion 61a of the inner skin 46. Another post 71 is positioned between the inner surface of the end portion 59b of the outer skin 42 and the outer surface of the end section 414. A plurality of spaced-apart fasteners 426, such as rivets, extend through the end section 408 of the plate 402, the end portion 59b of the outer skin 42, the post 71, the end section 414 of the plate 404, and the end portion 61b of the inner skin 46.

Alternatively, the end sections 406, 408 of plate 402 can sit between the inner surface of the end portions 59a, 59b of the outer skins 42 and the post 71; or the end sections 412, 414 of plate 404 can sit against the inner surface of the end portions 61a, 61b of the inner skins 46 such that the post 71 sits against the outer surface of the end portions 61a, 61b of the inner skins 46; or the end sections 412, 414 of plate 404 can sit between the posts 71 and the inner surface of the end portions 59a, 59b of the outer skins 42 (although the configuration of the end portions 418, 420 would be slightly changed) such that the post 71 also sits against the outer surface of the end portions 61a, 61b of the inner skins 46; or the end sections 412, 414 of plate 404 can sit between the outer surface of the end portions 59a, 59b of the outer skins 42 and the end sections 406, 408 of plate 402 (although the configuration of the end portions 418, 420 would be slightly changed) such that the post 71 sits against both the outer surface of the end portions 61a, 61b of the inner skins 46 and the inner surface of the end portions 59a, 59b of the outer skins 42 (in this configuration, the plates 402, 404 could be integrally formed); or the plate 402 may be removed and replaced by overlapping outer skins 42 of the type generally disclosed in FIGS. 5 and 11 (both outer skins 42 may span the gap or only one of the outer skins 42 may span the gap). In these alternative configurations, the width of the post 71 is accordingly adjusted. It is to be understood that other variations of connections between the outer and inner skins 46, 42, between the posts 71, between the end sections 406, 408 of plate 402, and between the end sections 412, 414 of plate 404, can be provided in keeping with the spirit of the invention. It is further to be understood that, if desired, structural adhesives may be provided to further secure one or more of the outer and inner skins 46, 42, the posts 71, and the plates 402, 404 together. It is also to be understood that the plates 402, 404 may be planar members such that the intermediate sections 410, 416 are planar with the flat end sections 406, 408; 412, 414.

In FIG. 18, a plate 402, identical to that shown in FIG. 14, is provided which extends between the adjacent ends 63, 65 of the outer skins 42, and a plate 504, which may be a logistics plate, is provided which extends between the adjacent ends 63, 65 of the inner skins 46.

In this joint 44, the adjacent end portions of the inner skins 46 are stepped by suitable means to form an offset 98 from the remainder of the inner skin surface. The offset 98 extends to the ends 63, 65 of the inner skins 46. The plate 504 is planar and has end sections 512, 514 and an intermediate section 516 therebetween. Logistics apertures 517 may be provided in the intermediate section 516. The end sections 512, 514 sit against the inner surfaces of the respective offsets 98 formed in the end portions 61a, 61b of the adjacent inner skins 46 and the intermediate section 516 spans the distance between the adjacent ends 61a, 61b of the inner skins 46. The plate 514 is thus preferably flush with the remainder of the inner skins 46. It should be noted that the offsets 98 formed in the end portions 61a, 61b need not extend all the way to the ends 63, 65 of the inner skins 46 as illustrated, but that, in this instance, minor changes to the plate 504 would need to be made such that the end sections 512, 514 of the plate 504 would sit against the inner surfaces of the respective offsets 98 formed in the end portions 61a, 61b of the adjacent inner skins 46, and such that the intermediate section 516 would not be planar with the end sections 512, 514.

A post 71 is positioned between the inner surface of the end portion 59a of the outer skin 42 and the outer surface of the offset 98 formed in the inner skin 46. A plurality of spaced-apart fasteners 524, such as rivets, extend through the end section 406 of the plate 402, the end portion 59a of the outer skin 42, the post 71, the offset 98 of the inner skin 46, and the end section 512 of the plate 504. Another post 71 is positioned between the inner surface of the end portion 59b of the outer skin 42 and the outer surface of the offset 98 formed in inner skin 46. A plurality of spaced-apart fasteners 526, such as rivets, extend through the end section 408 of the plate 402, the end portion 59b of the outer skin 42, the post 71, the offset 98 of the inner skin 46, and the end section 514 of the plate 504.

Alternatively, the end sections 406, 408 of plate 402 can sit between the inner surface of the end portions 59a, 59b of the outer skins 42 and the post 71; or the end sections 512, 514 of plate 504 can sit against the outer surface of the end portions 61a, 61b of the inner skins 46 such that the posts 71 sit against the end sections 512, 514; or the end sections 512, 514 of plate 504 can sit between the posts 71 and the inner surface of the end portions 59a, 59b of the outer skins 42 (although the configuration of the end portions 518, 520 would be slightly changed) such that the post 71 also sits against the outer surface of the end portions 61a, 61b of the inner skins 46; or the end sections 512, 514 of plate 504 can sit between the outer surface of the end portions 59a, 59b of the outer skins 42 and the end sections 406, 408 of plate 402 (although the configuration of the end portions 518, 520 would be slightly changed) such that the post 71 sits against both the outer surface of the end portions 61a, 61b of the inner skins 46 and the inner surface of the end portions 59a, 59b of the outer skins 42 (in this configuration, the plates 402, 504 could be integrally formed); or the plate 402 may be removed and replaced by overlapping outer skins 42 of the type generally disclosed in FIGS. 5 and 11 (both outer skins 42 may span the gap or only one of the outer skins 42 may span the gap). In any of these configurations, the end sections of the outer skins 42 could also be stepped in a manner similar to the end portions of the inner skins 46 such that offset portions are formed. In any of these configurations, the width of the post 71 is accordingly adjusted. It is to be understood that other variations of connections between the outer and inner skins 46, 42, between the posts 71, between the end sections 406, 408 of plate 402, and between the end sections 512, 514 of plate 504, can be provided in keeping with the spirit of the invention. It is further to be understood that, if desired, structural adhesives may be provided to further secure one or more of the outer and inner skins 42, 46, the posts 71, and the plates 402, 504 together. It is also to be understood that the plate 402 may be a planar member such that the intermediate sections 410 is planar with the flat end sections 406, 408. It is further to be understood that the plate 504 may not be a planar member such that the intermediate section 516 bulges outwardly from the flat end sections 512, 514.

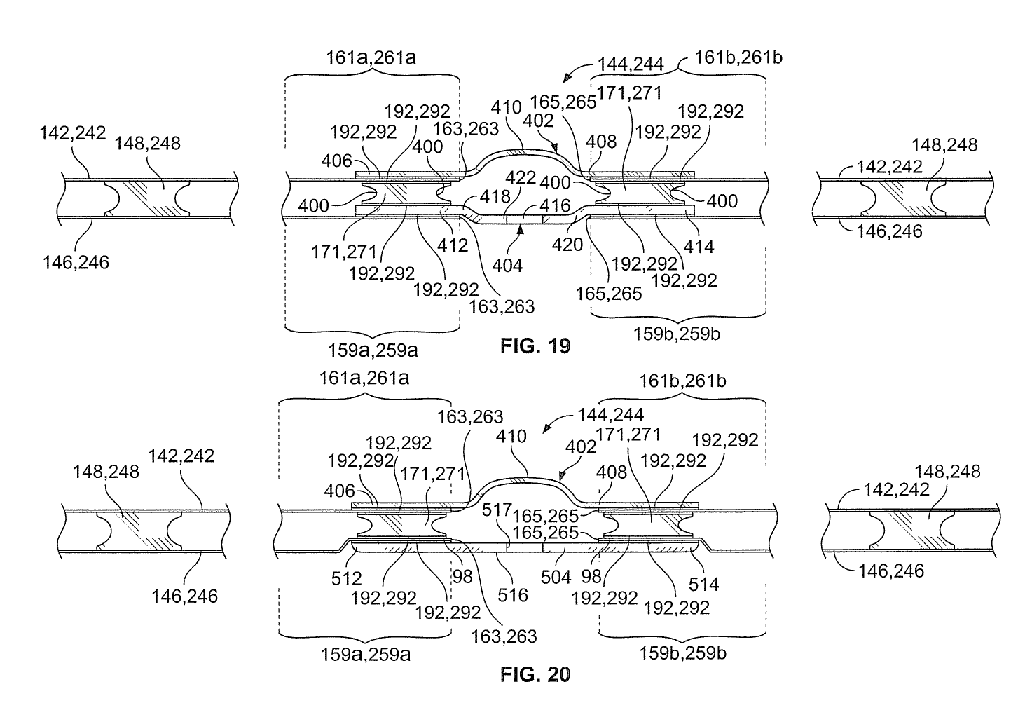

As shown in FIGS. 19 and 20, alternate joints 144, 244 for joining the panels 123 in the second embodiment and the panels 223 in the third embodiment are provided.

In the joint 144, 244 shown in FIG. 19, the only differences from the embodiment shown in FIG. 17 is that the fasteners 424, 426 have been eliminated and, instead, structural adhesive 192, 292 is used to join the skins 142, 242; 146, 246, the plates 402, 404 and the posts 71 together along the adjacent surfaces thereof. Therefore, the specifics of the structures of these elements is not repeated. It should be understood that, while not illustrated or preferred, that the structural adhesive 192, 292 may be removed from either between the posts 71 and the outer skins 142, 242, or from between the posts 71 and the plate 404.

In the joint 144, 244 shown in FIG. 20, the only differences from the embodiment shown in FIG. 18 is that the fasteners 524, 526 have been eliminated and, instead, structural adhesive 192, 292 is used to join the skins 142, 242; 146, 246 the plates 402, 504 and the posts 71 together along the adjacent surfaces thereof. Therefore, the specifics of the structures of these elements is not repeated. It should be understood that, while not illustrated or preferred, that the structural adhesive 192, 292 may be removed from either between the posts 71 and the outer skins 142, 242, or from between the posts 71 and the inner skins 146, 246.

In each embodiment, the components of the sidewall 22, 122 and 222, such as the inner and outer skins, the posts, the top and bottom rails, all have flat surfaces, making them ideally suitable for bonded joints.

The posts 48, 71, 148, 171, 248, 271 transmit shear. It should also be noted that the structural adhesives discussed herein may be identical to one another of different as desired.

While the present sidewall 22, 122 and 222 is shown and described with a plurality of outer and inner skins to form the sidewall, it is to be understood that a single outer skin and/or a single inner skin could be provided which extends along the entire length of the sidewall, eliminating the individual panels.

While preferred embodiments of the present invention are shown and described, it is envisioned that those skilled in the art may devise various modifications of the present invention without departing from the spirit and scope of the appended claims.

The invention claimed is:

1. A sidewall of a trailer comprising:
an inner skin;
an outer skin, said outer skin being spaced apart from said inner skin by a predetermined width; and
at least one of a bottom rail and a top rail having a portion thereof extending between said inner and outer skins, said portion generally spanning the width between said inner and outer skins.

2. The sidewall as defined in claim 1, wherein said portion is secured to at least one of said inner and outer skins by at least one of a fastener and an adhesive.

3. The sidewall as defined in claim 1, further including a scuff plate secured to said inner skin by at least one of a fastener and an adhesive.

4. The sidewall as defined in claim 1, further including at least one post provided between said inner and outer skins.

5. The sidewall as defined in claim 4, wherein said at least one post is secured to at least one of said inner and outer skins by at least one of a fastener and an adhesive.

6. The sidewall as defined in claim 5, wherein said portion is secured to at least one of said inner and outer skins by at least one of a fastener and an adhesive.

7. The sidewall as defined in claim 4, wherein a bottom end of said at least one post faces an upper end of said portion of said bottom rail.

8. The sidewall as defined in claim 4, wherein a top end of said at least one post faces a lower end of said portion of said top rail.

9. The sidewall as defined in claim 4, wherein said top rail and said bottom rail are spaced apart a distance and said post extends between said top rail and said bottom rail substantially all of said distance.

10. The sidewall as defined in claim 4, wherein said top rail and said bottom rail are spaced apart a distance and said post extends between said top rail and said bottom rail all of said distance.
